(19) United States
(12) Patent Application Publication
(10) Pub. No.: US 2021/0160655 A1
(43) Pub. Date: May 27, 2021

(54) DEVICE LOCATION METHOD

(71) Applicant: HUQ INDUSTRIES LIMITED, Winchester (GB)

(72) Inventor: Isambard Poulson, London (GB)

(21) Appl. No.: 16/757,039

(22) PCT Filed: Oct. 17, 2018
(86) PCT No.: PCT/GB2018/052984

§ 371 Date: Apr. 17, 2020

(30) Foreign Application Priority Data
Oct. 17, 2017 (GB) 1717032.5

(51) Int. Cl. H04W 4/021; H04L 29/08; H04W 4/029

(52) U.S. Cl. CPC H04W 4/022; H04W 4/029; H04L 67/18

(57) ABSTRACT

A computer-implemented method comprises, as a result of an application being executed, determining a set of one or more regions, wherein detecting entry into and/or exit from one or more of the regions is indicative of a change in the location of a device, and making one or more notification requests, wherein each of the notification requests comprises a request for a notification from an operating system that the device has entered into or exited from one of the regions. Further, the method comprises, repeatedly, in response to at least one of the notifications, executing a set of instructions, updating the set of regions based on the location of the device, and updating the notification requests based on the updated set of regions.

The present application relates among other things to a computer-implemented method relating to the location of a device.

Aggregated anonymised user location data is useful to many businesses engaged in modelling current activity in order to predict future activity. For example, footfall within a retail environment may have a correlation with revenue of the stores within that environment and therefore modelling changes in footfall patterns may be instructive to businesses marketing within that environment.

However, collecting data regarding to location of individuals causes both technical and logistical difficulties. The location of a mobile device, typically a mobile phone, is a useful indicator of the location of the owner of the device. Many mobile phone uses rely on device location in order to interact effectively with various applications. For example, mapping applications and the provision of directions relies on knowledge of the location of the device. A further example is the provision of public transportation timetables relevant to the user's location. Many users enjoy gaming activities that are related to locations in the real world. It is well known in the art for the location of the device to be ascertained.

There are various different methodologies that can be deployed to ascertain the location of a device. These include, but are not limited to GPS, WiFi, Bluetooth® and other available contextual signals.

However, the aggregation and communication of data concerning the device's location still presents logistical and technical problems. The repeated updating of location can drain the device's battery. Furthermore, many applications only update the device location data when the application is active. This results in an incomplete log of the user's location over time.

It is against this background that the present invention has arisen.

According to a first aspect of the present invention, there is provided a computer-implemented method comprising:

as a result of an application being executed:
and
making one or more notification requests, wherein each of the notification requests comprises a request for a notification from an operating system that the device has entered or exited one or more of the regions;
determining a set of one or more regions, wherein detecting entry into and/or exit from one or more of the regions is indicative of a change in the location of a device; and

repeatedly, in response to at least one of the notifications:
executing a set of instructions;
updating the set of regions based on the location of the device; and
updating the notification requests based on the updated set of regions;

wherein the method continues when the application enters a non-active state.

Thus, the method is intended to provide a way of enabling a set of instructions to be executed whenever there is a change in the location of a device. The method is intended to be energy efficient relative to previous methodologies that have repeatedly provided device location data, even when the device remains within a single location. Also, once started as a result of the application being executed, the method may be able to continue regardless of a state of the application. This enables the method to provide a more complete picture of the locations visited by the user including dwell time at these locations.

For example, if the application being executed provides live train arrival/departure boards, then the application will locate the device in order to give location relevant departure boards. The application may offer the user to selection of train stations close to the user's current location. The user may select a train station, review the data provided and then cease to use the application, which will continue to run in the background until or unless it is forced to close by the device. Throughout this non-active time, the device location is tracked and information about the device location is stored, for communication to the operating system when the application is active at a subsequent time.

When the application is subsequently activated, the stored data will be communicated to the operating system. The data will include the location of the user from the point where they activated to application to check on their train's expected departure time and will then chart their subsequent location data, showing that, for example, the user visited one or more shops before arrival at the station and then left the train and moved to the home post code area. From this information, it will be apparent that the user will have passed certain advertising hoardings, for example. By aggregating the data from a plurality of users it will be possible to correlate shopping habits, train journeys and postcode areas. Using these correlations, it will be possible for marketing on the advertising locations in these areas to be selected to have maximum impact for the demographic of users frequenting these routes.

The notifications may be provided by the operating system determining the location of the device based at least in part on wireless local area networks in the vicinity of the device (e.g. based on Wi-Fi positioning). This is a lower power methodology for determining device location than relying on GPS data. The device detects the presence and strength of various networks and uses this visibility of networks to determine the device location. Data is not transferred via any of these networks, which may be unavailable to the device. However, the mere presence of the network is sufficient to glean useful information about the location of the device without having to transfer data using these networks.

Thus, a change in the location of the device may be determined relatively efficiently, compared to using a satellite navigation system receiver, for example.

Determining or updating the set of regions may comprise obtaining the location of the device from the operating system.

The part of the method that is carried out in response to the at least one of the notifications may be carried out when the application is in a non-active (e.g. a background) state.

Thus, the method may be more energy efficient because there is no need for the application to be kept in an active state. Also, the method may be more robust because the method may be able to continue even if the application is put into a non-active state. This ensures that the method is capable of aggregating a full picture of the device location over time without the requirement for continuous updates and without the application being in the active state at all times.

Updating the notification requests may comprise: cancelling any of the notification requests that relate to regions not included in the updated set of regions; and making any one or more further notification requests based on the updated set of regions. This provides the advantage that activity is avoided when the device has not moved. Therefore streamlining the use of power and data connection and avoiding unnecessary or repeated transmissions of the same information.

The updated set of regions may be completely different from the previous set of regions and so the method may comprise cancelling all of the previous notification requests.

Exiting or entering a region may be referred to as crossing a geofence.

Determining or updating the set of regions may comprise: determining at least one region of a first type comprising the location of the device.

Accordingly, exiting a region of the first type is indicative of a change in the location of the device. The region of the first type may be a region within a particular radius of the location of the device. The radius may be, for example, several (2 to 9) metres or several tens or hundreds of metres or several kilometres or more. The radius may be tailored, for example to a particular application.

Determining or updating the set of regions may comprise: determining one or more regions of a second type not comprising the location of the device, wherein the regions of the second type together at least partly surround the location of the device.

Accordingly, entering a region of the second type is indicative of a change in location of a device. This provides an alternative or additional way of obtaining an indication of a change in the location of the device.

The regions of the second type may together comprise a boundary of the first region. Each of the regions of the second type may partly overlap the first region. The part of the method that is carried out in response to at least one of the notifications may be carried out in response to a combination of: a first notification associated with exit from the region of the first type; and/or at least one second notification associated with entry into at least one of the regions of the second type.

Each of these optional features may provide a more reliable indication of a change in the location of the device.

The method may comprise executing instructions for only a predetermined period of time after the at least one of the notifications.

Thus, as a background operation, a complete picture of the device location can be built up including dwell time in each location. This is in sharp contrast to the sporadic data stream if the method is useable only when the relevant application is active.

Executing the set of instructions may comprise: selectively transmitting data to a server.

Executing the set of instructions may comprise taking different actions. For example, data may be stored for later use or transmission.

The data may comprise location-related data, for example data specifying the location of the device. The method is particularly suited for location-related data because it is responsive to a change in the location of the device. That said, the method may also be used in relation to other types of data that may need to be repeatedly transmitted etc such as network data including network name data, and unique identifier for Bluetooth® devices.

The method may comprise transmitting the data to the server in response to determining that the device is connected to the internet via a wireless local area network.

Thus, the method can avoid networks that may be less cost- and/or power-efficient, such as mobile data networks.

The method may comprise avoiding transmitting the data to the server if the device is connected to the same wireless local area network as a last-used wireless local area network (i.e. the wireless local area network to which the device was connected when the data was last transmitted to the server). The method may comprise avoiding transmitting the data to the server if a time since the data was last transmitted is below a minimum time.

Thus, these optional features may streamline transmissions in order to optimise use of data transfer and device power.

Executing the set of instructions may comprise selectively determining the location of the device by a method comprising activating a satellite navigation system receiver.

Thus, the location of the device may be determined more accurately when appropriate.

The part of the method that is carried out in response to at least one of the notifications may be carried out in response to at least one of the notifications or in response to a notification of a significant location change.

Thus, if there is a significant location change without entry into and/or exit from one or more of the regions being detected, then the method may still continue.

There may be provided a computer program for performing the method.

There may be provided a non-transitory computer-readable medium comprising the computer program.

There may be provided apparatus configured to perform the method.

The apparatus may comprise at least one processor and at least one memory comprising computer program code, the at least one memory and the computer program code configured to, with the at least one processor, cause the apparatus to perform the method.

### BRIEF DESCRIPTION OF THE DRAWINGS

Certain embodiments of the present invention will now be described, by way of example, with reference to the accompanying drawings, in which:

FIG. 1 illustrates a system.

FIG. 2 illustrates certain hardware features of a device which may be part of the system of FIG. 1.

FIG. 3 illustrates certain software features of the device of FIG. 2.

FIG. 4 illustrates a method for use by the device of FIG. 2.

FIG. 5 illustrates regions determined at a second step of the method of FIG. 4.

FIG. 6A-C illustrates monitoring of the location of the device of FIG. 2 (carried out at the fifth step of the method of FIG. 4) and possible detection of entry into and/or exit from the regions of FIG. 5 (carried out at the sixth step).

FIG. 7 illustrates the twelfth step of the method of FIG. 4, and a corresponding step carried out by the server of FIG. 1.

FIG. 8 illustrates updated regions determined at a thirteenth step of the method of FIG. 4.

FIG. 9 illustrates the fifteenth step of the method of FIG. 4.

### DETAILED DESCRIPTION OF THE CERTAIN EMBODIMENTS

System

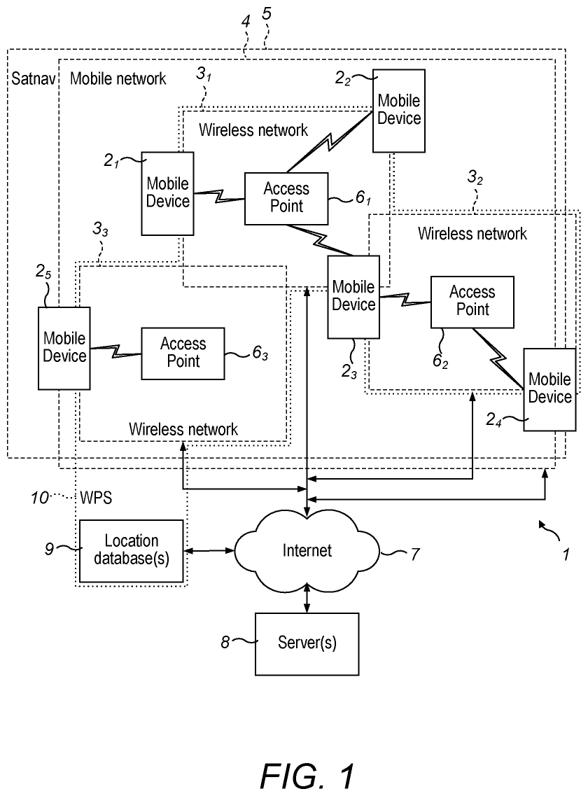

Referring to FIG. 1, a system 1 will now be described.

The system 1 includes one or more mobile devices 2 (hereinafter referred to as “devices”). The figure shows five devices 2₁-2₅, but there may be any number of devices 2. The devices 2 may be mobile telephones, etc.

The system 1 includes communications systems 3, 4, 5 of several different types.

In particular, the system 1 includes several wireless local area networks 3 (hereinafter referred to as “wireless networks”). The figure shows three wireless networks 3₁-3₃, but there may be any number of wireless networks 3. As devices 2 change their location, they will encounter different wireless networks 3. A wireless network 3 with which the device 2 can communicate is hereinafter sometimes referred to as a “visible wireless network”. A wireless network 3 has one or more wireless access points 6 to enable devices 2 to connect to the wireless network 3. The wireless networks 3 are typically connected to the internet 7.

Furthermore, the system 1 includes a mobile network 4. A device 2 is typically able to communicate with the mobile network 4. The mobile network 4 is typically connected to the internet 7. In some examples, there may be more than one mobile network 4.

Furthermore, the system 1 includes a global navigation satellite systems 5 (hereinafter referred to as a “satnav system”). The satnav system 5 may be the Global Positioning System (GPS), etc. In some examples, there may be more than one satnav system 5.

The system 1 includes a computer server 8 (hereinafter referred to as the “server”). The server 8 is connected to the internet 7. A device 2 may send data to the server 8 in particular circumstances, as will be explained in more detail below. In some examples, there may be more than one server 8.

Location Determination

A device 2 is able to determine its location in several different ways.

Firstly, a device 2 may receive and use data from the satnav system 5 to determine its location. In such circumstances, the device 2 may also use data from the mobile network 4 to assist in determining its location. Typically, using the satnav system 5 is a relatively accurate, but requires a relatively large amount of energy usage by the device 2.

Secondly, a device 2 may use so-called “Wi-Fi positioning” to determine its location. This may involve:
receiving a beacon frame from a (wireless access point 6 of a) visible wireless network 3;
identifying the wireless network 3, for example using a service set identifier (SSID) in the beacon frame;
determining the location of the wireless network 3, for example using one or more location databases 9, which may be stored remotely and accessible via the Internet 7;
estimating a distance to the wireless network 3, for example using a received signal strength indicator (RSSI);
repeating the above steps for several different visible wireless networks 3; and
estimating the location of the device 2 using the information determined at the previous steps and a technique such as, for example, trilateration.

In this example, Wi-Fi positioning is carried out using a set of wireless networks 3 and one or more location databases 9. These elements may be collectively referred to as a “Wi-Fi positioning system (WPS)” 10.

In other examples, Wi-Fi positioning may be carried out in a different way and/or using a different type of WPS 10. There may be more than one WPS 10.

Using Wi-Fi positioning to determine location is typically less accurate but requires less energy usage by the device 2 compared to using the satnav system 5.

Device

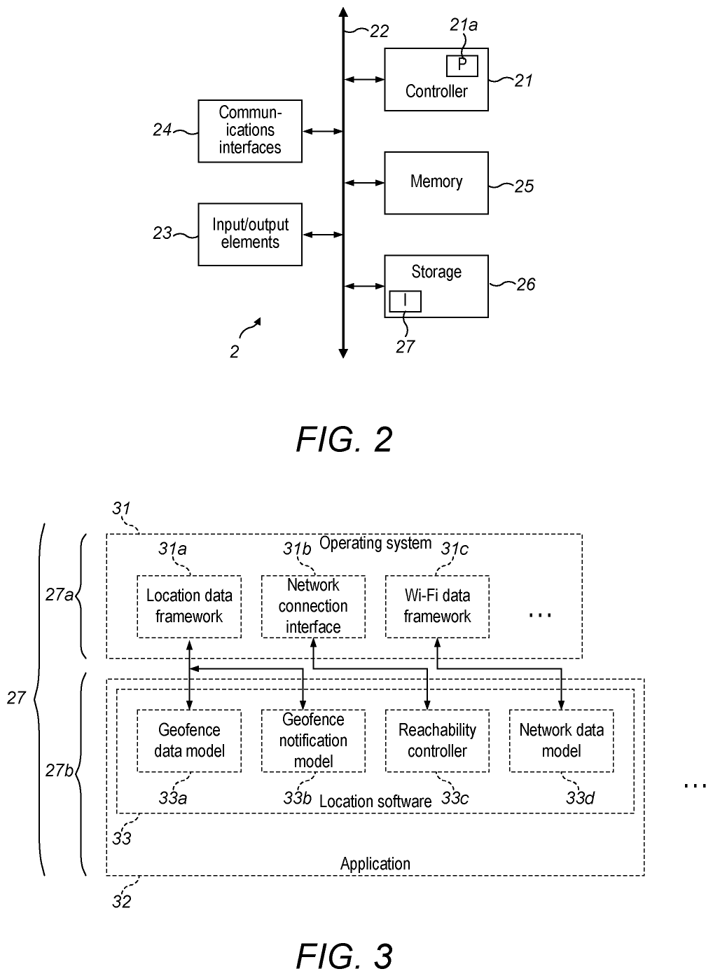

Referring to FIG. 2, a typical device 2 will now be described in more detail.

The device 2 includes a controller 21 which includes one or more processors (P) 21a. The controller 21 communicates, via a system bus 22, with other elements of the device 2.

The device 2 includes one or more input/output (I/O) elements 23. The I/O elements 23 may include a touch-sensitive display including a screen and a tactile interface. In this case, the controller 21 receives inputs from the tactile interface and controls the display on the screen. The I/O elements 23 may also include one or more cameras, microphones, speakers, sensors, haptic feedback systems, light-emitting diodes, hardware buttons, etc,

The device 2 includes one or more communications interfaces 24. The communications interfaces 24 include one or more transceivers for communicating over mobile communications links (e.g. GSM/EDGE, UMTS/I-ISPA+, DC-HSDPA, 4G LTE), wireless network links (e.g. 802.11a/b/g/n/ac), Bluetooth links, and so forth. The communications interfaces 24 typically also include a satnav system (e.g. GPS) receiver.

The device 2 includes memory 25 including volatile memory (e.g. RAM) and non-volatile memory (e.g. ROM). The volatile memory is used by the controller 21 for the temporary storage of data, for instance when controlling operations of other elements of the device 2 or moving data between elements.

The device 2 also includes storage 26 such as, for example, solid-state storage. The storage 26 stores, among other things, computer-readable instructions (I) 27 used in operating the device 2. These computer-readable instructions 27 are hereinafter referred to as “device software”.

Server

The server 8 may be similar to the abovedescribed device 2 or may include a cluster of such devices. The server 8 may be a virtual machine. The server 8 may be part of a cloud-computing platform.

Device Software

Referring to FIG. 3, the device software 27 will now be described in more detail.

The device software 27 includes system software 27a and application software 27b. The system software 27a includes an operating system 31. The application software 27b includes one or more application programmes 32 (hereinafter referred to as “applications”). At least one of the applications 32 (hereinafter referred to as the “relevant application” or simply “the application”) includes software 33 (hereinafter referred to as “location software”) that is described in more detail below.

In some examples, the operating system 31 includes several parts 31a, 31b, 31c, each of which provides one or more services that are used by the location software 33.

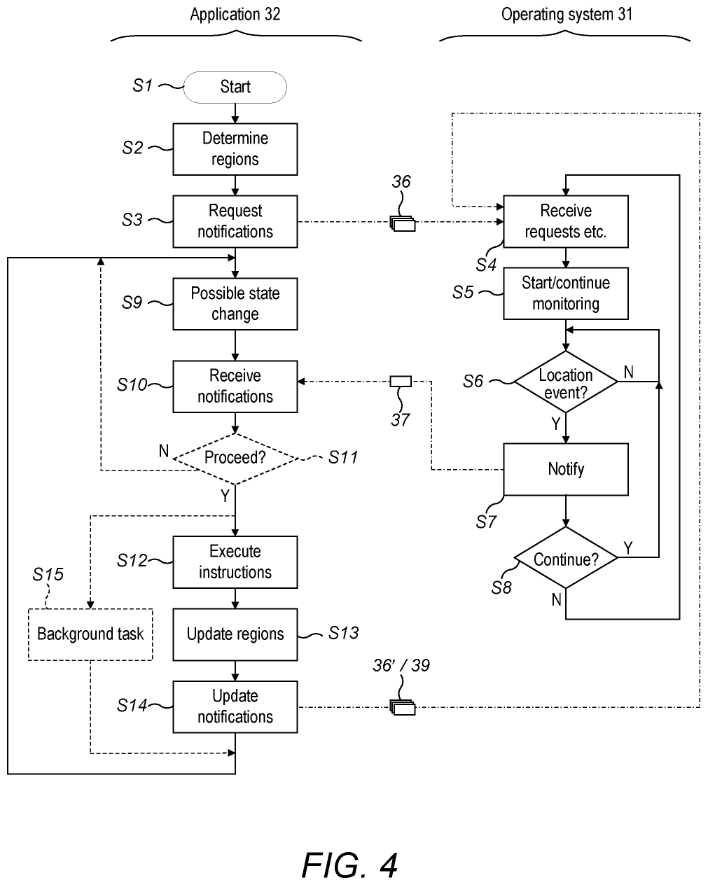

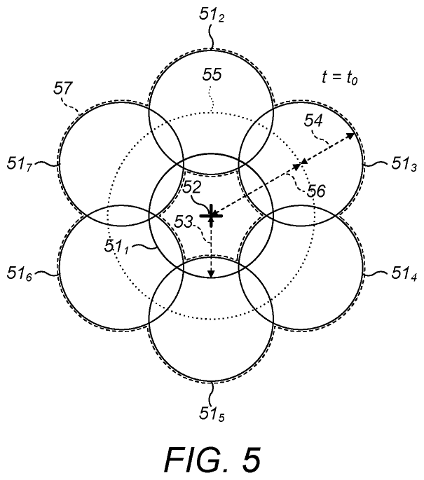

In particular, the operating system 31 includes a first part 31a (hereinafter referred to as the “location data framework”) that:
provides the current location of the device 2. The current location of the device 2 may be updated by the operating system 31 from time to time using various methods including, for example, using a WPS 10 or a satnav system 5; and
enables the definition of one or more regions 51 (hereinafter referred to as “geofenced regions”; see FIG. 5) and provides notifications 37 (see FIG. 4) when the device 2 enters or exits a geofenced region 51.

The operating system 31 includes a second component 31b (hereinafter referred to as the “network connection interface”) that enables access to visible wireless networks 3. The network connection interface 31b also provides lower-level (e.g. transport layer) information about visible wireless networks 3. In some embodiments, the network connection interface 31b only provides lower-level information about connected wireless networks 3.

The operating system 31 includes a third component 31c (hereinafter referred to as the “Wi-Fi data framework”) that provides higher level information about visible or connected wireless networks 3.

In some examples, the location software 33 includes several components 33a-33d.

In particular, the location software 33 includes a first component 33a (hereinafter referred to as the “geofence data model”) that enables the device 2 to manage an active set of geofenced regions 51₁-51₇ (see FIG. 5).

The location software 33 includes a second component 33b (hereinafter referred to as the “notification model”) that enables the device 2 to receive and process notifications 37. Processing notifications 37 involves, for example, de-duplicating the notifications 37 and cleaning the data included therein.

The location software 33 includes a third component 33c (hereinafter referred to as the “reachability controller”) that enables the device 2 to detect points in time when the device 2 connects to or disconnects from a wireless network 3. This may be achieved by detecting whether data can be routed via that network 3 to the internet 7.

The location software 33 includes a fourth component 33d (hereinafter referred to as the “network data model”) that enables the location software 33 to maintain a record of sessions during which the device is connected to a wireless network 2. For each session, the record preferably includes information identifying the wireless network 2 and timing information (e.g. start time and end time or duration of the session).

The geofence data model 33a and notification model 33b interact with the location data framework 31a. The reachability controller 33c interacts with the network connection interface 31b. The network data model 33d interacts with the Wi-Fi data framework 31c

The relevant application 32 may be of any type, for example an entertainment, lifestyle or shopping application. The relevant application is typically a third-party application installed by a user of the mobile device (hereinafter referred to as “the user”). The location software 33 is typically included in the application 32 using a software-development kit (SDK).

At any particular time, the relevant application 32 may be in one of several states including:
a “foreground” state in which the application 32 is being actively used by the user and has relatively unlimited access to resources of the device 2 (e.g. processing power) and to services of the operating system 31;
a “background” state in which the application 32 is not being actively used by the user and has generally limited access to resources of the device 2, but may receive certain notifications from the operating system 31 and perform certain tasks; or
a “closed” state in which the application 32 has been closed (e.g. by the user or by the operating system 31) and is unable to perform any tasks without first receiving certain notifications from the operating system 31 or the user.

The foreground state may be referred to as an “active” state, whereas the background and closed states may be collectively referred to as “non-active” states. The relevant application 32 will generally be non-active for most of the time. The above-described limitations seek to prolong the battery life of the device 2 and prevent a potentially large number of applications 32 from consuming resources of the device 2.

Certain types of operating system 31 will only allow an application 32 in the background to execute code for a certain period of time (e.g. 3 minutes) in certain circumstances. One of these circumstance is when a device 2 enters or leaves a geofenced region 51 set by the application 32.

Method

Referring in particular to FIGS. 4 to 9, a method for use by a device 2 will now be described.

Referring in particular to FIG. 4, at a first step S1, the relevant application 32 is started or, in other words, executed. The first step S1 is typically initiated by the user, for example via the I/O elements 23.

At a second step S2, the application 32 determines a set of regions 51₁-51₇ based on the current location 52 of the device 2 (hereinafter referred to as the “current location”).

The second step S2 is carried out as a result of the application 32 being executed. The second step S2 may be carried out as one of the first actions of the application 32 or at any suitable stage during execution of the application 32.

The current location 52 is obtained from the operating system 31, or in any other suitable way.

Referring in particular to FIG. 5, in some examples, the set of regions 51 includes seven regions 51₁-51₇. The set of regions 51₁-51₇ includes a region 51₁ of a first type (hereinafter referred to as a “central region”) and six regions 51₂-51₇ of a second type (hereinafter referred to as “outer regions”).

The central region 51₁ contains the current location 52, and, in particular, is centred on the current location 52. The central region 51₁ is circular. The radius 53 of the central region 51₁ (hereinafter referred to as the “first radius”) may be, for example, several metres, or several tens or hundreds of metres, or several kilometres. In some embodiments, the first radius 53 may be constant In some embodiments, the first radius 53 may be variable. A variable first radius is particularly applicable in circumstances where the device undergoes considerable variations in speed. For example, when the device is moving at a high speed, the first radius may be increased in order to streamline the number of notifications that would occur due to the device repeatedly exiting its central region.

The outer regions 51₂-51₇ are each circular. The radius 53 of each of the outer regions 51₂-51₇ (hereinafter referred to as the “second radius”) is the same as the first radius. None of the outer regions 51₂-51₇ contain the current location 52. The outer regions 51₂-51₇ together form a combined region 57. The combined region 57 surrounds the current location 52 and, furthermore, contains the boundary of the central region 51₁. Accordingly, the outer regions 51₂-51₇ may be centred on points that are evenly spaced around a circle 55 with a (“third”) radius 56 that is greater than each of the first and second radii 53, 54 and less than twice the cosine of half the angular separation of the outer regions 51₂-51₇.

In other examples, the set of regions may differ from the above-described set of regions 51. For instance, there may be no central region. There may be more than one central region. There may be no outer regions. There may be less than six or more than six outer regions. The inner and/or outer regions may have different sizes and/or shapes. The position(s) of the inner and/or outer regions relative to the current location 52 may differ. The position(s) of the inner and/or outer regions relative to the current location 52 may be constant or variable.

Referring in particular to FIG. 4, at a third step S3, the application 32 makes a set of notification requests 36 to the operating system 31. In particular, the application 32 requests a notification if the device 2 exits the central region 51₁. For each of the outer region 51₂-51₇, the application 32 requests a notification if the device 2 enters the outer region 51₂-51₇. The application 32 preferably requests a notification if there is a significant change in the location of the device 2 (hereinafter referred to as a “significant location change”). Significant location changes will be explained in more detail below. An exit from a geofenced region 51, an entry into a geofenced region 51, or a significant location change is hereinafter sometimes referred to as a “location event”.

At a fourth step S4, the operating system 31 receives the notification requests 36.

At a fifth step S5, the operating system 31 starts (or, if already started, continues) monitoring the location of the device 2 using the WPS 10.

At a sixth step S6, the operating system 31 detects whether any of the location events specified in the notification requests 36 have occurred. In particular, the operating system 31 detects whether the device 2 has:
exited the inner region 51₁;
entered an outer region 51₂-51₇; or
undergone a significant location change.

Generally, the device 2 might be unable to use the WPS 10 during certain periods of time, for example when the device 2 is unable to communicate with wireless networks 3 for whatever reason (e.g. the device 2 is switched off). Accordingly, the device 2 might cross geofences associated with the regions 51 without this being detected by the operating system 31. Thus, the operating system 31 is preferably configured to detect significant location changes in addition to detecting the crossings of geofences. This may be carried out in any suitable way, for example, using GPS.

If it is determined that a location event has occurred, then the flow proceeds to a seventh step S7. Otherwise, the sixth step S6 is repeated.

At the seventh step S7, the operating system 31 provides a notification 37 to the application 32. The notification 37 includes data enabling the location event detected at the sixth step S6 to be identified. For example, the notification 37 includes data identifying the region 51 that has been entered or exited, etc.

At an eighth step S8, the operating system 31 determines whether to continue detecting location events. If it is determined to continue detecting location events, then the flow returns to the sixth step S6. Otherwise, the flow returns to the fourth step S4.

In parallel with above-described operations of the operating system 31 (which may extend over a relatively long period of time, e.g. hours), at a ninth step S9, the application 32 may undergo a change in state. In particular, the application 32 may remain in the foreground (if the user continues to use the application 32) or may go to the background (if the user stops using the application 32) or may be closed.

At a tenth step S10, the application 32 receives the notification 37 provided by the operating system 31 at the seventh step S7. The application 32 is preferably able to receive the notification 32 regardless of the state of the application 32. For example, if the application 32 has been closed, then the operating system 31 may cause the application 32 to re-open in the background as part of the tenth step S10.

At an eleventh step S11, the application 32 determines whether there has been a particular (“relevant”) change in the current location. As will be explained in more detail below, this determination is based on the notification 37 received at the tenth step S10 (and may also be based on previously-received notifications 37). If it is determined that there has been a relevant change in the current location, then the flow proceed to a twelfth step S12 (see below). Otherwise, the flow returns to the ninth step S9.

Notifications 37 will generally be provided with varying and unpredictable accuracy. This is because, amongst other things, Wi-Fi positioning uses relatively noisy and imprecise signals (e.g. RSSI). Moreover, the wireless access points 6 from which these signals are obtained are unevenly distributed and there may be large area without any wireless access points 6.

In light of this, the regions 51₁-51₇ are arranged as described above such that, if the device 2 moves (i.e. is displaced) a particular distance, then the device 2 will both exit the central region 51₁ and enter one of the outer regions 51₂-51₇.

In some examples, the application 32 determines that there has been a relevant change in the current location if it receives both a notification 37 that the device 2 has exited the central region 51₁ and a notification 37 that the device has entered one of the outer regions 51₂-51₇.

In other examples, the application 32 determines that there has been a relevant change in the current location if it receives either a notification 37 that the device 2 has exited the central region 51₁ or a notification 37 that the device has entered one of the outer regions 51₂-51₇.

These fallback and overlapping triggers may significantly increase the likelihood of detecting when the device 2 moves across a boundary indicating that the device 2 has moved from one region into another region.

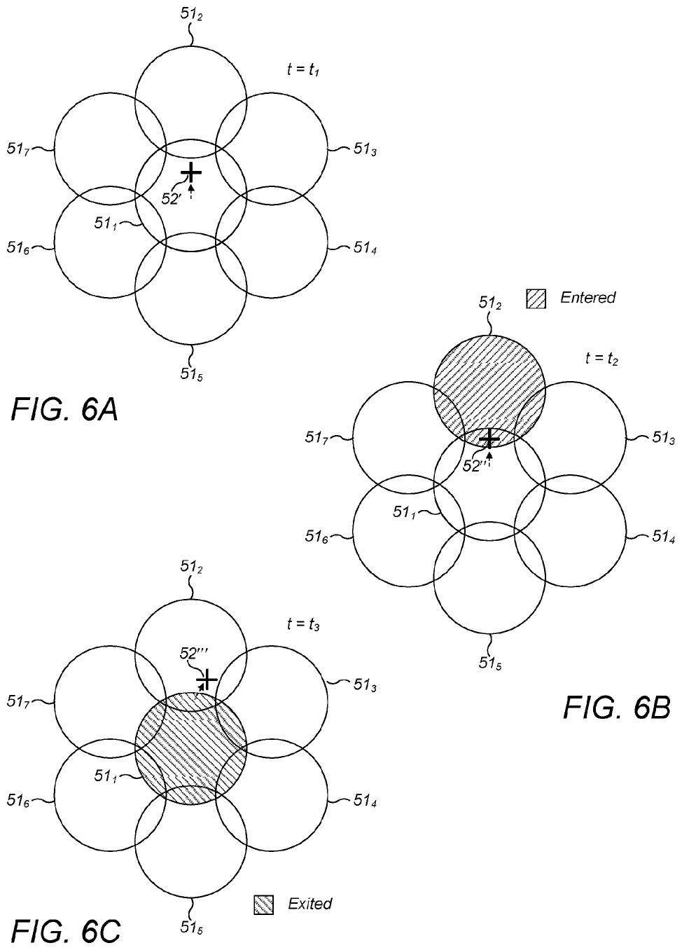

Referring in particular to FIGS. 6A-C, an example scenario in which a device 2 moves relative to the set of regions 51₁-51₇ will now be described.

In FIG. 6A, at a certain time (t=t₁), the device 2 has moved to a current location 52′ that is different from the current location 52 at the time (t=t₀, see FIG. 5) when the set of regions 51₁-51₇ was determined. The movement is illustrated by the arrow in the figure. The movement does not involve crossing any geofences and accordingly there are no notifications 37.

In FIG. 6B, at a later time (t=t₂), the device 2 has moved to a new current location 52″ that is still within the inner region 51₁ but also within one of the outer regions 51₂. Because the device has entered an outer region 51₂, a corresponding notification 37 is provided.

In FIG. 6C, at an even later time (t=t₃), the device 2 has moved to a new current location 52′″ that is outside the inner region 51₁ and still within the outer region 51₂ Because the device has exited the inner region 51₁, a corresponding notification 37 is provided.

As explained above, the application 32 may determine that there has been a relevant change in the current location at the second time t₂ or at the third time t₃.

Preferably, the application 32 determines that there has been a relevant change whenever it receives a notification 37 of a significant location change.

The notifications 37 may also be processed (e.g. de-duplicated) at the eleventh step S11.

Referring in particular to FIG. 4, as mentioned above, if it is determined that there has been a relevant change in the location of the device 2, then the flow proceeds to the twelfth step S12.

At the twelfth step S12, the application 32 executes a set of instructions. The set of instructions are associated with, and preferably form part of, the application 32. As will become apparent, the set of instructions include, for example, the reachability controller 33c and the network data model 33d.

In some examples, the set of instructions cause the device 2 to selectively transmit data to the server 8.

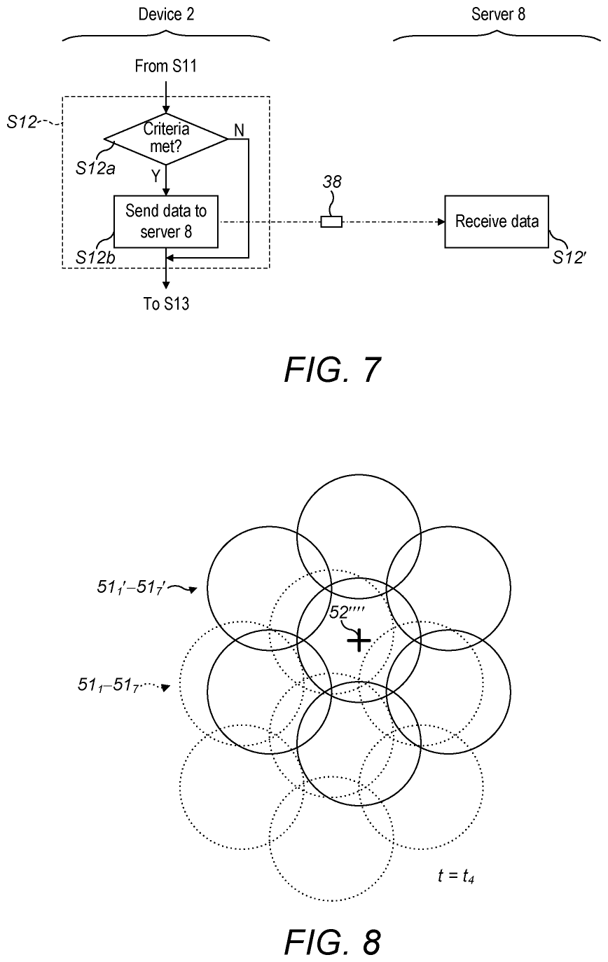

Referring in particular to FIG. 7, in such an example, the twelfth step S12 includes the following sub-steps:

At a first sub-step S12a, the application 32 determines whether one or more criteria are met In some examples, the criteria include:
1. that the device 2 is currently connected to the internet 7 via a wireless network 3 (hereinafter referred to as the “current wireless network”);
2. that the device 2 can determine the identity (e.g. SSID) of the current wireless network 3 and that this identity is not the same as the identity of the wireless network 3 to which the device 2 was connected when data was last transmitted to the server 8; and/or
3. that the time since the device 2 (successfully) transmitted data to the server 8 exceeds a predetermined minimum time (e.g. several seconds or more or less).

As will be appreciated, a device 2 may connect to wireless networks 3 in irregular ways. For example, a device 2 may connect to and disconnect from a particular wireless network 3 several times in quick succession. The above-described criteria may be used to avoid obtaining information arising from such circumstances, which may be of little or no value.

In this example, if all of the above-described criteria (i.e. criteria 1, 2 and 3) are met, then the flow proceeds to a second sub-step S12b. Otherwise, no data is transmitted to the server 8, and the flow proceeds to the thirteenth step S13.

At the second sub-step S12b, data 38 (hereinafter referred to as “transmitted data”) is transmitted to the server 8.

The transmitted data 38 may include data specifying the current (and/or recent) location(s) of the device 2. The transmitted data 38 may include contextual data related to the location(s), e.g. information about wireless networks 3, etc.

The transmitted data 38 may include any type of data, for example any data that may need to be repeatedly transmitted, etc.

The transmitted data 38 may be in JavaScript Object Notation (JSON) format. The transmitted data 38 may include a set of key-value pairs for items such as an identity of the wireless network 3 to which the device 2 is connected, the current location of the device 2, and other data which may be specific to the device 2 or to the application 32.

At a third sub-step S12c, the server 8 receives the transmitted data 38. The server 8 may store and/or process the data in any suitable way. For example, the server 8 may aggregate the data.

In some examples, the set of instructions may cause the device 2 to take other actions.

For instance, in addition to, or as alternative to, selectively transmitting data to the server 8, the device 2 may store the data for later use.

The set of instructions may cause the device 2 to record its location at each occurrence of the twelfth step S12, thereby enabling the (approximate) distance travelled by the device 2 to be monitored in an energy efficient way.

The location and/or contextual data may be provided to, and used by, (other parts of the) the application 32.

The set of instructions may cause the device 2 to perform any task that should be run repeatedly (e.g. at more or less regular intervals) including when the application 32 is in the background.

Referring in particular to FIGS. 4 and 8, at a thirteenth step S13, the application 32 determines an updated set of regions 51₁′-51₇′ based on a new current location 52″″. The thirteenth step S13 is preferably carried out in the same way as the second step S2 (described above).

At a fourteenth step S14, the application 32 updates the set of notification requests 36.

Typically, the updated set of regions 51₁′-51₇′ is completely different from the previous set of regions 51₁-51₇. In this case, the application 32 cancels the previous set of notification requests by making one or more suitable requests 39 (hereinafter referred to as “notification cancellation requests”) to the operating system 31.

The application 32 makes an updated set of notification requests 36′ to the operating system 31 in the same way as the third step S3 (described above).

Referring in particular to FIG. 4, in parallel with the twelfth, thirteenth and fourteenth steps S12, S13, S14, at a fifteenth step S15, the application 32 also preferably performs a background task.

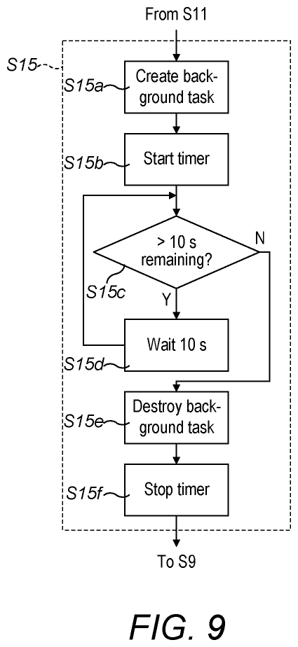

Referring in particular to FIG. 9, the fifteenth step S15 includes the following sub-steps:

At a first sub-step S15a, a background task 15a is created.

At a second sub-step S15b, a timer is started.

At a third sub-step S15c, it is determined whether there is more than a predetermined length of time (e.g. 10 seconds) until the timer reaches a predetermined maximum time (e.g. 3 minutes). In other words, it is determined whether or not a period of time has almost elapsed.

If it is determined that the period of time has not almost elapsed, then the flow proceeds to a fourth sub-step S15d, at which the application 32 waits (for e.g. the predetermined length of time) before repeating the third sub-step S15c.

If it is determined that the period of time has almost elapsed, then the flow proceeds to a fifth sub-step S15d, at which the background task is destroyed, and then to a sixth sub-step S15e, at which the timer is stopped.

Accordingly, at the fifteenth step S15, the application 32 maintains a background task for a period of time of, for example, 3 minutes. As mentioned above, certain types of operating system 31 will only allow an application 32 in the background to execute instructions for up to a certain period of time (e.g. 3 minutes) after receiving a (geofence-crossing) notification 37.

After the fourteenth and/or fifteenth steps S14, S15, the flow returns to the ninth step S9. Accordingly, the application 32 may again undergo a change in state and may then again receive one or more notification 37, in response to which the twelfth to fifteenth steps S12-S15 may be repeated.

Accordingly, the method may continue for a relatively long period of time, for example until the device 2 is powered off.

As will be appreciated, some of the advantages of the invention are only obtained when the application 32 is non-active state (when active, the application 32 could detect changes in the location of the device 2 and execute the set of instructions in other suitable ways). Nevertheless, in some examples, for the sake of robustness and simplicity, the application 32 preferably carries out the relevant steps (e.g. sending (updated) notification requests 36, 36′ and receiving notifications 37) regardless of whether or not it is active.

Referring in particular to FIGS. 3 and 4, the second and third steps S2, S3 are preferably carried out by the geofence data model 33a; the fourth to eighth steps S4-S8 by the location data framework 31a; the tenth and eleventh steps S10, S11 by the geofence notification model 32b; the twelfth step S12 by, amongst other things, the reachability controller 32c, the network data model 33d, the network connection interface 31b and the Wi-Fi data framework 31c; and the thirteenth and fourteenth steps S13, S14 by the geofence data model 33a.

It will be appreciated that many other modifications may be made to the above-described embodiments.

For example, as an alternative to or in addition to using Wi-Fi positioning, the operating system 31 may use a different type of positioning system that also preferably requires relatively low energy usage by the device 2.

Instead of being provided by the operating system 31, the notifications 37 may be provided by another type of software 27.

The system 1 need not include a server 8.

1. A computer-implemented method comprising:
as a result of an application being executed:
making one or more notification requests, wherein each of the notification requests comprises a request for a notification from an operating system that the device has entered or exited one or more of the regions;
determining a set of one or more regions, wherein detecting entry into and/or exit from one or more of the regions is indicative of a change in the location of a device; and
repeatedly, in response to at least one of the notifications:
executing a set of instructions;
updating the set of regions based on the location of the device; and
updating the notification requests based on the updated set of regions,
wherein the method continues when the application enters a non-active state.

2. The method according to claim 1, wherein the notifications are provided by the operating system determining the location of the device based at least in part on wireless local area networks in a vicinity of the device.

3. The method according to claim 1, wherein determining or updating the set of regions comprises obtaining the location of the device from the operating system.

4. The method according to claim 1, wherein the part of the method that is carried out in response to the at least one of the notifications is carried out when the application is in a non-active state.

5. The method according to claim 1, wherein updating the notification requests comprises:
cancelling any of the notification requests that relate to regions not included in the updated set of regions; and
making any one or more further notification requests based on the updated set of regions.

6. The method according to claim 1, wherein determining or updating the set of regions comprises:
determining at least one region of a first type comprising the location of the device.

7. The method according to claim 6, wherein determining or updating the set of regions comprises:
determining one or more regions of a second type not comprising the location of the device, wherein the regions of the second type together at least partly surround the location of the device.

8. The method according to claim 7, wherein the regions of the second type together comprise a boundary of the first region.

9. The method according to claim 7, wherein each of the regions of the second type partly overlap the first region.

10. The method according to claim 7, wherein the part of the method that is carried out in response to at least one of the notifications is carried out in response to:
a combination of:
a first notification associated with exit from the region of the first type; and/or
at least one second notification associated with entry into at least one of the regions of the second type.

11. The method according to claim 1, comprising:
executing instructions for only a predetermined period of time after the at least one of the notifications.

12. The method according to claim 1, wherein executing the set of instructions comprises:
selectively transmitting data to a server.

13. The method according to claim 12, wherein the data comprises location-related data.

14. The method according to claim 12, further comprising transmitting the data to the server in response to determining that the device is connected to the internet via a wireless local area network.

15. The method according to claim 12, further comprising avoiding transmitting the data to the server if the device is connected to the same wireless local area network as the wireless local area network to which the device was connected when the data was last transmitted to the server.

16. The method according to claim 12, further comprising avoiding transmitting the data to the server if a time since the data was last transmitted is below a minimum time.

17. The method according to claim 1, wherein executing the set of instructions comprises selectively determining the location of the device by a method comprising activating a satellite navigation system receiver.

18. The method according to claim 1, wherein the part of the method that is carried out in response to at least one of the notifications is carried out in response to at least one of the notifications or in response to a notification of a significant location change.

19. (canceled)

20. A non-transitory computer-readable medium comprising instructions configured to carry out a method according to claim 1.

21. An apparatus configured to perform a method according to claim 1.
